(19) United States
(12) Patent Application Publication
(10) Pub. No.: US 2020/0061515 A1
(43) Pub. Date: Feb. 27, 2020

(54) REPLACEABLE HVAC FILTER

(71) Applicant: Robert E. MERTON, Jacksonville, FL (US)

(72) Inventor: Robert E. MERTON, Jacksonville, FL (US)

(21) Appl. No.: 16/113,396

(22) Filed: Aug. 27, 2018

(51) Int. Cl. B01D 46/42; B01D 46/00; B01D 46/10; B01D 53/04

(52) U.S. Cl. CPC B01D 46/4227; B01D 46/0036; B01D 46/0005; B01D 46/10; B01D 2259/4508; B01D 2279/50; B01D 2253/102; B01D 2253/108; B01D 53/04

(57) ABSTRACT

A device is adapted for facilitating the removal and replacement of standardized HVAC vent system filters for primarily return air flow where contaminants are caught in the filter. The device includes a substantially rigid frame defining the perimeter of the filter, a designated location of the frame for attaching a removal device and an elongated tool for engaging the removal device for facilitating removal of the filter. The filter system may include a filter substrate mounted in the frame and containing an active ingredient to further improve the filter function.

### BACKGROUND OF THE INVENTION

### Field of the Invention

The subject invention is directed to removable and replaceable filter systems for HVAC units and is specifically directed to a tool which may be integral or separate and portable for use not only with new filter systems but as a retrofit for filters currently in use.

### Discussion of the Art

Many HVAC systems have a replaceable filter carried in a specific opening positioned in the return air flow side of the system plenum. Known filters of this type are typically available for consumers in such home stores as Lowes or Home Depot. In general, it is recommended that these filters be replaced between every 30 days or every three months, depending on local climate conditions. Most of these filters include a wire mesh back side to hold the filter media in place as the air flows through the system. The filter media may be of any of a variety of tightly assembled particulate matter or mesh designed to entrap larger particles in the filter to partially cleanse the air flowing therethrough. 3-M is one company that makes such filters. Typically, the filter elements are made of a passive material which captures particles based on size relative to the particulate matter making up the mesh.

Most of these filters are carried in a frame, typically made of cardboard or similar material. The filters are installed in the HVAC receptacle and are held in place by the pressure differential between the air intake side and the opposite exhaust side of the system. Because a relatively tight fit is desired, to maximize filter efficiency, the filters can be difficult to remove, once installed.

In addition, the passive media is deficient in that it does not remove airborne contaminants other than the particulate matter which is larger than the mesh filter media. it is desirable to have a filter system which is active, rather than passive, and to have a system for facilitating the removable and replacement of the filter unit.

### SUMMARY OF THE INVENTION

The subject invention is directed to a replaceable filter system that fits in the vast majority of installed HVAC systems as well as being readily adaptable to new or future systems. The mesh filter element includes at least two active ingredients such as activated charcoal, zeolite, other active materials, or the like. This captures or neutralizes contaminants in addition to the particulate matter which is historically trapped by the mesh filter element.

The subject invention may also include a separate or an integral removal device to facilitate change-out of the filter. The integral removal device and the active material may be used in combination or as independent features. In addition, the removal device may be used with prior art filter systems as well as new systems.

The active material may be embedded in the standard single layer system or may be contained in one or more separate layers of media in the filter assembly.

One form of the removal device is a separate elongated tool designed to facilitate the removal of the filter. Another form of the removal device is an elongated tab mounted directly on the filter frame prior to installation or just before filter removal. The device may be retrofitted or may be an integral part of a new assembly. When configured as an integral part of the filter frame, the device is designed to be prepared for use prior to installation or just before filter removal. When the device is part of the filter assembly it is positioned such that it can be accessed without moving the filter. When the device is separate from the filter, the device is temporarily attached to the filter to facilitate removal of the filter. It is then separated from the filter allowing the filter and/or device to be disposed of as appropriate. The filter removal can be disposable or reusable depending upon specific configuration.

### BRIEF DESCRIPTION OF THE DRAWINGS

FIG. 1 is a front view of the filter system showing the inclusion of an activate ingredient in addition to the prior art passive material.

FIG. 2 is a side view of FIG. 1 and shows the active matter embedded in the passive mesh.

FIG. 3 is a view looking in the same direction as FIG. 2, showing a separate grid layer for the active matter, laid over the passive mesh.

FIG. 4 is a view looking in the same direction as FIGS. 2 and 3, showing multiple active materials, each in a separate layer.

FIG. 5 is a side view of a variation of the removal device which is used as a retrofit tool.

FIGS. 6, 7 and 8 another variation of the removal device used to remove the filter.

FIGS. 9 and 10 are perspective views of the removal device of FIGS. 6-8, showing the tool in position to facilitate removal of the filter.

FIGS. 11, 12 and 13 show a modified version of the removal device as an integral part of the frame.

FIGS. 14 and 15 show an additional version of the removal device, operating similar to that shown in FIGS. 9-10.

FIGS. 16, 17 and 18 show another modified version of the removal tool, operating similar to that shown in FIGS. 6-10.

### DETAILED DESCRIPTION

The subject invention is shown in two parts, (I) the inclusion of active material in the media grid(s) and (2) the inclusion of a removal tool. Parts (1) and (2) may be used together or separately.

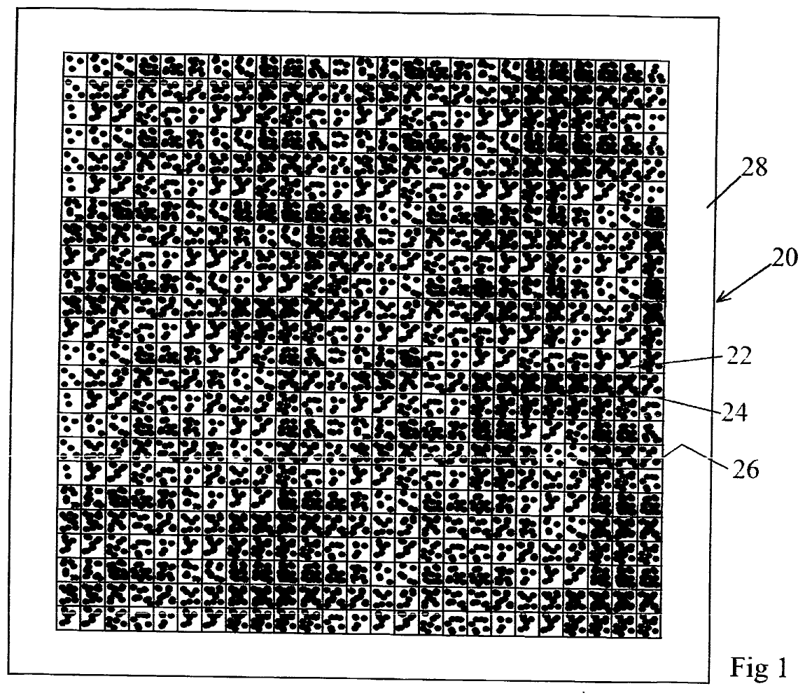

Turning first to part (I}, a typical removable, disposable filter 20 is shown in FIG. 1. In typical fashion the passive media 22 is held in a grid 24 which is secured to a frame 28. In the preferred embodiment an active media, such as activated charcoal 26 is dispersed in the media grid.

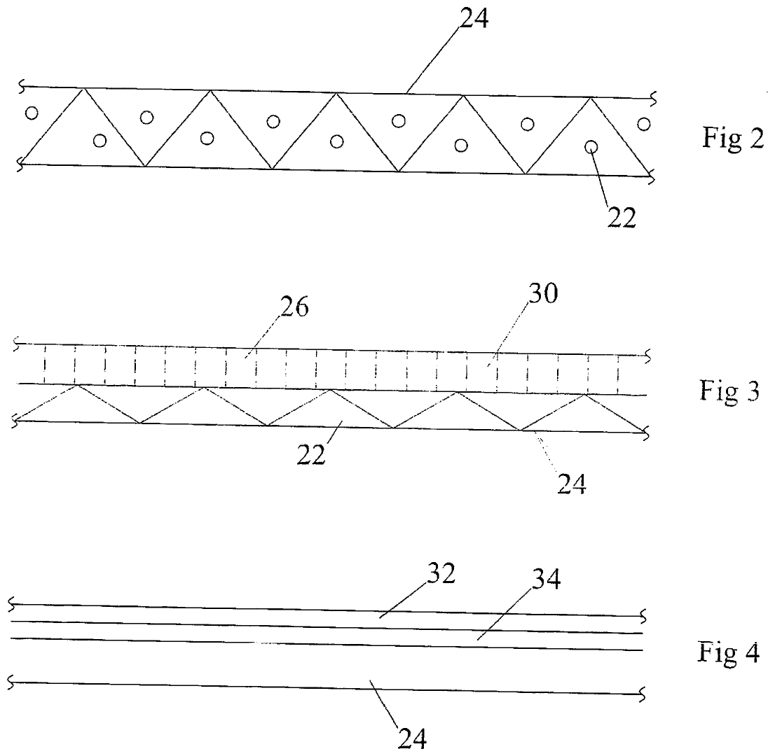

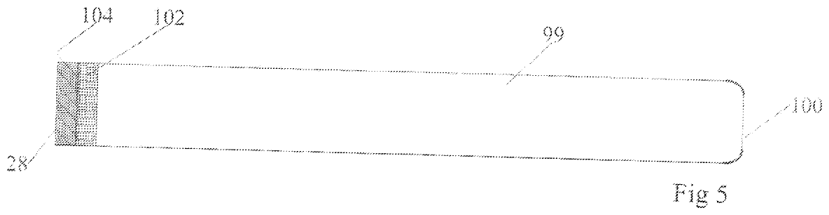

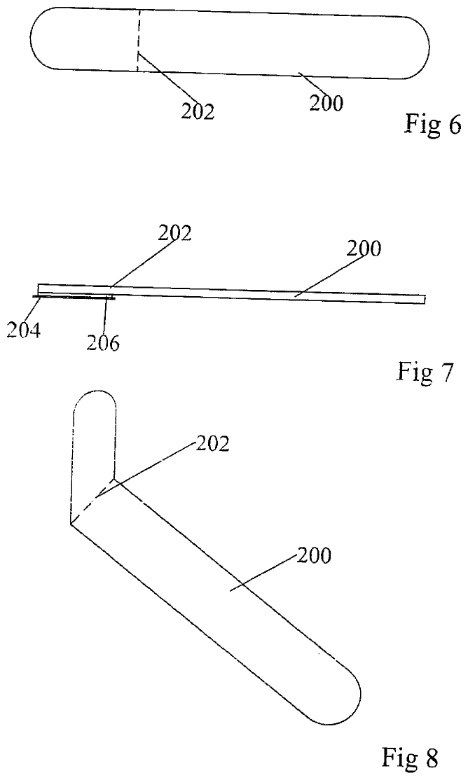

As shown in FIGS. 2, 3 and 4, the activated material can be activated charcoal, zeolite, or other material 26 depending on application in specific climate conditions In FIG. 2. The active material is embedded in the media grid 24. In FIG. 3, the activated material 26 is laid in a separate grid in parallel juxtaposition with the passive grid 24. In FIG. 4, each ingredient is in separate parallel grids or layers. Specifically, the passive media is in grid 24. A first active material is in juxtaposed grid 34 and a second active material is in juxtaposed grid 32.

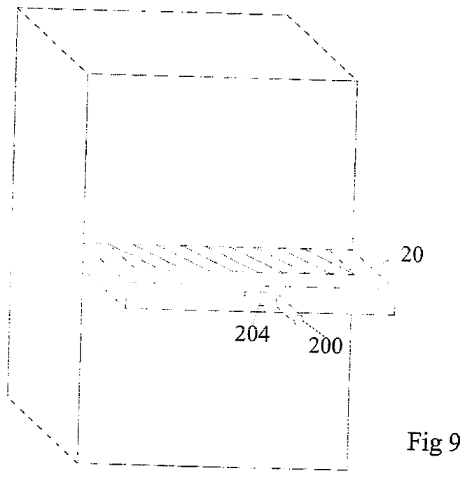

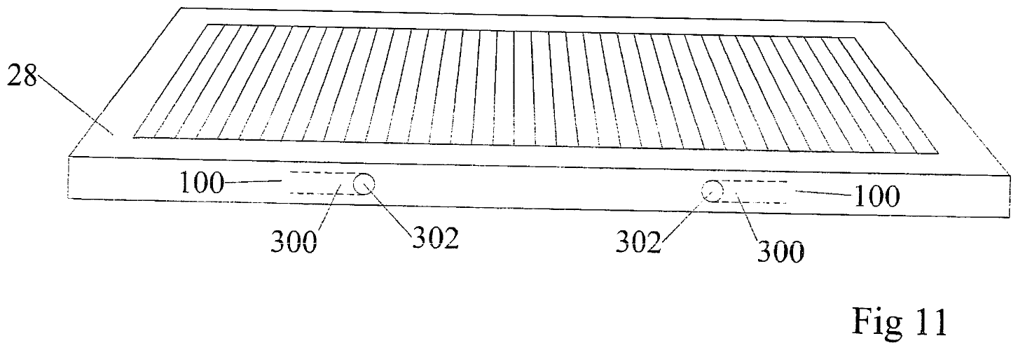

Part (2) of the application is shown in FIGS. 5-18. As shown in FIG. 5, the removal device 100 may be used as a retrofit tool to remove existing filters. As shown, removal device 100 is an elongated tab 99 made of a relatively rigid material such as plastic, stiff cardboard or wood. In the diagram the device is shown with a Velcro pair utilized to move a filter. One side of the button or pad 102 is permanently mounted on one end of the tab 100. The opposite side of the button pair has an adhesive face intended to be affixed to the filter to facilitate removal. In one configuration, the button is made of a Velcro type material with the adhesive side 104 of the button adapted to be pressed against the filter frame 28. The tab is then maneuvered to remove the filter system. Once removed, the tab is removed from the frame with the adhesive portion 104 staying adhered to the frame. A new button tab Velcro assembly may be attached for reuse of the tab.

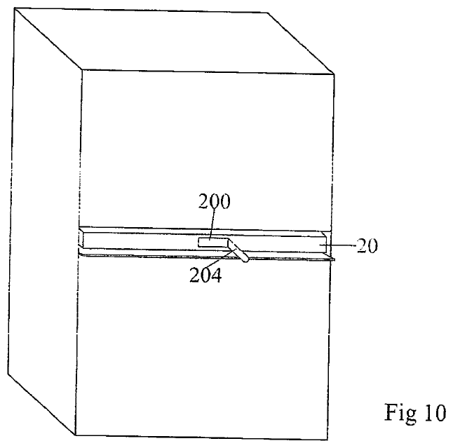

As shown in FIGS. 6-10, double sided tape or other adhesives may be used as well as the previously mentioned Velcro. In the assembly of FIGS. 6-10, the tab 200 is hinged at 202. Double sided tape or similar adhesive pad 204 is placed on the end tab 200 and outboard of the hinge 202. As shown in 9 and 10, the pad 204 is positioned against the filter frame 28 and engages the frame for removal of the filter. Depending on the type of adhesive used, a protective cover 206 may be included. This would be removed prior to use.

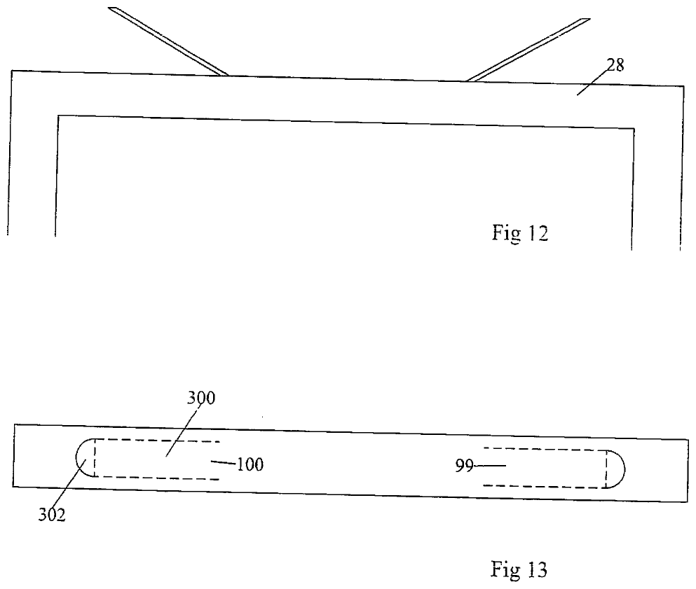

As shown in FIGS. 11, 12 and 13, the tab 100 can be defined by a perforated section or sections 300 of the frame 28. The perforated sections are incorporated during the manufacturing process. One or more finger holes 302 may be incorporated whereby the tab can be lifted to engage and remove the filter. The tab may be prepared for use prior to the installation of the filter or just prior to filter removal

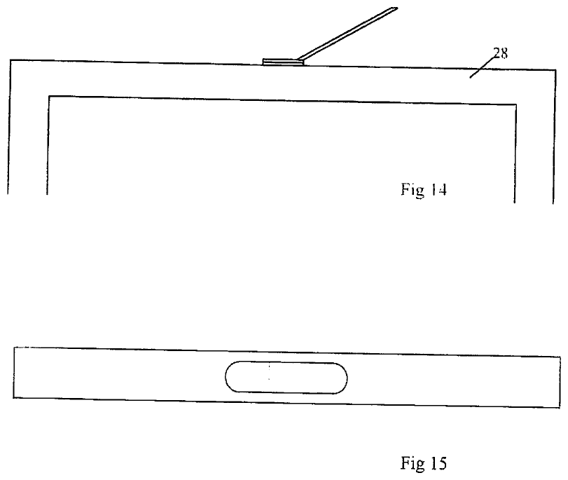

FIGS. 14 and 15 are similar to FIGS. 6-10, showing placement of the tabs 200 near the center of a frame 28 leg.

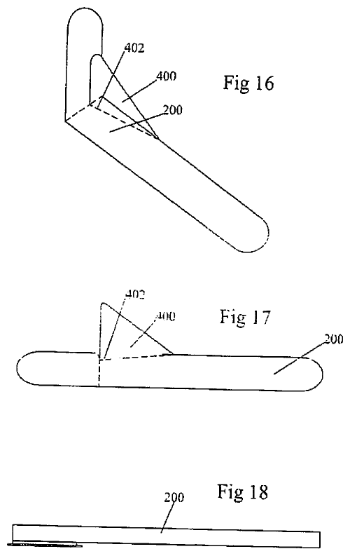

FIGS. 16-18 show a modification of the System of FIGS. 14 and 15, with the tab 200 modified to have a hinged “wing” 400 which may be folded along a perforated line or crease 402 to provide increased leverage for removal if needed.

While certain features and embodiments of the invention have been described in detail herein, it should be understood that the invention encompasses all modifications and enhancements within the scope and spirit of the following claims.

1. A device for facilitating the removal and replacement of standardized HVAC vent system filters for primarily return air flow where contaminants are caught in the filter, comprising:
a. A substantially rigid frame defining the perimeter of the filter;
b. A designated location of the frame for attaching a removal device;
c. An elongated tool for engaging the removal device for facilitating removal of the filter.

2. The device of claim 1, wherein the elongated tool is removably attached to the filter.

3. The device of claim 2, wherein the elongated tool is a perforated tab formed in the frame with one end releasably secured to the frame and the other end permanently secured to the frame.

4. The device of claim 3, wherein the elongated tool tab is an integral part of the frame.

5. The device of claim 3, wherein the elongated tool is mounted directly on the frame.

6. The device of claim 5, wherein the elongated tool includes an integral wing tab for further facilitating the removal of the filter.

7. The device of claim 6 wherein the integral wing tab is integral with the integral perforated tab.

8. The device of claim 1, wherein the elongated tool is separate from the filter.

9. The device of claim 8, wherein the elongated tool is separate from the filter and the device further includes an elongated tool with an adhesive tip and a mated adhesive tip located on the frame.

10. The device of claim 9, wherein the adhesive assembly is a hook and loop patch.

11. The device of claim 10 where the adhesive assembly is Velcro.

12. The device of claim 1, wherein the filter substrate is mounted in the frame and contains an active ingredient to further improve the filter function.

13. The device of claim 12, wherein the active ingredient is embedded in the substrate.

14. The device of claim 12, wherein multiple active ingredients are embedded in the substrate.

15. The device of claim 12, wherein the active ingredient is in at least one layer placed in overlying relationship with the filter substrate.

16. The device of claim 12, wherein there are multiple layers in overlying relationship with the filter substrate, each layer including a separate active ingredient.

17. The device of claim 14, wherein at least one active ingredient is activated charcoal.

18. The device of claim 12, wherein at least one active ingredient is Zeolite.
